(19) United States
(12) Patent Application Publication
(10) Pub. No.: US 2012/0053751 A1
(43) Pub. Date: Mar. 1, 2012

(54) DISTRIBUTED ELECTRICAL POWER PRODUCTION SYSTEM AND METHOD OF CONTROL THEREOF

(75) Inventors: Simon Børresen, Arhus N (DK); Klaus B. Hilger, Federicia (DK); Jan H. Mortensen, Fredericia (DK); Tommy Mølbak, Fredericia (DK); Kristian Skjoldborg Edlund, Fredericia (DK); John Bagterp Jørgensen, Bunkeflostrand (SE)

(73) Assignee: DONG ENERGY POWER A/S, Fredericia (DK)

(21) Appl. No.: 13/146,905

(22) PCT Filed: Jan. 29, 2010
(86) PCT No.: PCT/EP2010/051067

§ 371 Date: Nov. 16, 2011

Related U.S. Application Data
(60) Provisional application No. 61/149,496, filed on Feb. 3, 2009.

(51) Int. Cl. G05B 13/02; H02J 3/00

(52) U.S. Cl. 700/297

(57) ABSTRACT

The present invention relates to a distributed electrical power production system wherein two or more electrical power units comprise respective sets of power supply attributes. Each set of power supply attributes is associated with a dynamic operating state of a particular electrical power unit.

The present invention relates to a distributed electrical power production system wherein two or more electrical power units comprise respective sets of power supply attributes. Each set of power supply attributes is associated with a dynamic operating state of a particular electrical power unit

### BACKGROUND OF THE INVENTION

Distributed electrical power production systems where different types of remote or local power units are interconnected to and commonly controlled by a central computer are known in the art. Various examples of such distributed electrical power production systems are disclosed in publications US 2003/0144864, US 2005/0285574, US 2008/0188955, U.S. Pat. No. 5,323,328 and U.S. Pat. No. 3,719,809. Some of these electrical power production systems may comprise economic dispatch programs that plan how future electrical power demands can be met in an economical way by allocating available electrical power units in order of their relative production costs so as to minimize costs associated with meeting the demanded electrical power production.

Another distributed electrical power production system is disclosed in “Modelbased Fleet Optimization and Master Control of a Power Production System”, IFAC Symposium on Power Plants and Power System Control, Canada, 2006. The distributed power production system comprises a number of different types of power plants such as fossil fuel-fired plants, thermal plants, biomass-fired and wind-power plants. An advanced modelling and control system at all levels of the power production system seeks to make best possible use of power plant resources while complying with relevant constraints of economical and technical nature.

Prior art distributed electrical power production systems have traditionally been operated in a manner where a large portion of a planned electrical power production has been assigned according to fixed electrical power production schedules of power production units. The fixed electrical power production of each power production unit have been set in accordance with respective production plans for the power production units and computed by an economic dispatch program. Deviations between actual electrical power production, according to the production plans, and consumption, for example caused by short-term transients, have traditionally been corrected by one or more dedicated electrical power unit(s) assigned specifically to this task. The one or more dedicated electrical power unit(s) have been set in operation to produce a required amount of corrective electrical power to compensate for the detected power deviation, or imbalance, while maintaining the electrical power production of other power units on the production plan or schedule.

In accordance with the present invention, a master control system is connected to respective local control systems of first and second power units and receives attribute data representing their respective dynamic operating states. Deviations or imbalances between actual electrical power consumption and generation is reduced or eliminated by supplying respective amounts of corrective electrical power (which can have either negative or positive sign) by the first and second power units. Each of the first and second power units comprises an associated set of power supply attributes which indicate a dynamic operating state of the power unit in question. A power supply attribute may represent a generation rate constraint, a power reserve, a time constant or any other variable associated with electrical power production or consumption characteristics of one of the first and second power units.

The current values of the respective power supply attributes may be used by the master control system to determine the most appropriate way of distributing the production of corrective electrical power between the first and second power units to meet a performance measure or constraint.

The dynamic nature of the attribute data ensures that the master control system has access to current operating points of the first and second power units and therefore knowledge of relevant constraints related to a production of corrective electrical power for each of the first and second power units as reflected in values of the power supply attributes. Some of these constraints may be related to specific characteristics of the power unit in question and imparted by thermodynamic properties and/or dimensions of the power unit. For example, a large fossil fuel-fired plant may have relatively large time constants for increasing/decreasing its production of electrical power while a rechargeable energy reservoir may have a very small time constant for producing or delivering electrical power. Other constraints are related to a dynamic operating state of the power unit in question. For example, a power unit may at a particular moment in time be running at its full power production capacity, or it may be depleted of energy. The power unit may, depending on actual circumstances, therefore be unable to increase its electrical power production, or at least need recharging before being capable of regaining its ability to supply electrical power.

### SUMMARY OF INVENTION

According to a first aspect of the invention, there is provided a distributed electrical power production system comprising:
a first power unit of a first type adapted to produce electrical power in accordance with a first local control system,
the first power unit having a first set of power supply attributes associated with a dynamic operating state of the first power unit,
a second power unit of a second type adapted to produce electrical power in accordance with a second local control system,
the second power unit having a second set of power supply attributes associated with a dynamic operating state of the second power unit,
a master control system adapted to receive attribute data from the first and second local control systems representing respective values of their respective sets of power supply attributes,
the master control system being adapted to compare a desired or target set-point electrical power with a total electrical power supplied by the first and second power units and form a power deviation based thereon,
the master control system being operative to reducing the power deviation by supplying first and second correction signals to the first and second local control systems, respectively, causing the first and second power units to produce or consume respective amounts of corrective electrical power in accordance therewith. The master control system is adapted to distribute the amounts of corrective electrical power between the first and second power units based on the attribute data.

In accordance with the present invention, a master control system is operatively connected to the respective local control systems of first and second power units and receives attribute data representing values of their respective sets of power supply attributes. The master control system is preferably implemented as a software application or computer program running on a central computer such as a PC- or UNIX based server or cluster of servers. The master control system may be interconnected to each of the first and second local control systems by a wired, including dedicated telephone lines, or wireless data communication network operating according to communication standards such as LAN, WLAN, GSM, UMTS etc. The attribute data may be transmitted by an appropriate proprietary or standardized protocol for example Internet Protocol (TCP/IP). The wired or wireless data communication network should preferably support a sufficiently frequent transmission of the attribute data to allow these to reflect a dynamic operating state of each of the first and second power units as closely as possible. Each of the local control systems is adapted to determine and store current values of the set of power supply attributes based on the dynamic operating state of the power unit in question. Each of the local control systems may be based on computer programs running on local servers placed in proximity to the power production unit for example inside a factory building. However, due to the variety in types and sizes of power units suited for the present distributed power production system, a local control system may be formed as a suitably programmed embedded microcontroller or as a proprietary collection of logic and arithmetic units. These latter types of simple local control system would be particularly suitable for integration together with household appliances or similar types of relatively small power units.

In the present specification and claims the term “dynamic operating state” designates a thermodynamic and/or electrical process state of relevance for the ability of the power unit to consume or generate of electrical power. A dynamic operating state may for example be a boiler temperature, a steam temperature, a boiler pressure, a flow value of steam or water, a wind load, wing speed or pitch angle, a charging state of battery pack or assembly etc.

The availability to the master control system of current values of the first and second sets of power supply attributes ensures the master control system is capable of determining an appropriate distribution for the supply of corrective electrical power between the first and second production units. The current values of the first and second sets of power supply attributes also allow appropriate constraints associated with a particular power supply attribute to be derived in a dynamic manner. This is highly useful for master control system applying Model Predictive Control schemes to compute an appropriate distribution for the supply of corrective electrical power between the first and second power units. Updated or current attribute data represent an actual dynamic operation state of the power unit or units in question as opposed to obsolete or inaccurate attribute data reflecting past operating states of the power unit. Therefore, attribute data are preferably transmitted frequently to ensure current attribute data are available to the master control system. How frequently updated attribute data are transmitted in any particular embodiment of the present distributed power production system depends on the individual characteristics of the first, second and possible additional power units. It is particularly advantageous to ensure the master control system receives the updated attribute data at time interval or sampling time periods smaller than one half of the smallest time constants of the respective time constants of the first and second power units. This ensures that the dynamic operating state of each of the first and second power units is at least critically sampled, i.e. sampled at a rate above the Nyquist rate. In the context of distributed electrical power production systems, this means that the local control system of the power unit with the fastest response time, i.e. smallest time constant, may be interrogated or sampled for current values of its power supply attributes quite frequently for example at 20 seconds time intervals or even faster such as time intervals of less than 10 seconds, or less than 2 seconds. Respective sampling time periods of other power units with larger time constants may be set essentially identical to that of the power unit with the smallest time constant, or they may be longer and adapted to match the respective time constants in a manner where each power unit is sampled at a sampling rate faster or equal to its Nyquist rate. The required rates of transmission of the updated attribute data for complying with the above-mentioned range of sampling time periods are readily obtainable in modern data communication networks.

There are no constraints as to geographical location of first and second power units so these may be placed proximately such as on common premises of a power plant or inside a common building on the same power plant. The first and second power units may alternatively be placed at different geographical locations such different cities or counties or states separated by hundreds of kilometres, but coupled to a common power grid serviced by the present distributed power production system.

In the present specification, the term “power unit” refers to any electrical power producing or consuming apparatus operatively coupled to the master control system and capable of supplying electrical power into the present distributed electrical power production system and/or consuming electrical power from the present distributed electrical power production system. The first and second power units may accordingly both be adapted to exclusively consume electrical power from the distributed power production system. In this case the master control system will only be capable of compensating for a surplus of total electrical power relative to the target set-point electrical power by causing the first and second power units to consume respective amounts of corrective electrical power in accordance with a determined distribution by values of the respective power supply attributes. Electrical motors and household appliances are exemplary power units of this latter type. In many applications of the present invention, it will be impractical if the first and second power units are adapted to exclusively consume electrical power so at least one of the first and second power units may advantageously be adapted to produce electrical power to the distributed power production system.

One or both of the first and second power units may alternatively be capable of both producing electrical power to the distributed power production system and consuming electrical power there from.

The first and second power units are preferably selected from a group of {fossil fuel-fired plant, biomass fired plant, on- or offshore windmill plant, waste incineration plant, nuclear power plant, electrical vehicle, rechargeable energy reservoir, cold storage house, house-hold appliance, electrical motor}. The variety of characteristics, i.e. power producing, power consuming or both, and sizes of an individual power unit of the present distributed electrical power production system mean that the maximum power output or maximum power consumption of an individual power unit of the system may vary considerably for example from 100 kW up to 800 MW. The lower limit of 100 kW could represent a single small windmill or a small rechargeable energy reservoir such as a battery pack of an electrical vehicle.

The first and second sets of power supply attributes of the first and second power supply units, respectively, may comprise several power supply attributes of same type or different type depending on the characteristics of the first and second power units. Some types of power supply attributes may have greater relevance for certain types or categories of power units than others. The number and types of power supply attributes of a particular power unit can for example depend on whether the power unit is capable of only consuming electrical power, only producing electrical power or both. There is preferably a certain overlap between the types of the first and second set of power supply attributes to facilitate exploitation by the master control system to distribute the amount of correction power in direct proportion to current values of power supply attributes of the same type, for example current values of first and second time constants. It follows that the number of power supply attributes of the first and second sets of power supply attributes may differ or be the same.

The first set of power supply attributes preferably comprises at least one power supply attribute selected from a group of {a first generation rate constraint, a first power reserve, a first time constant, a first marginal power cost, a first energy reserve} and the second set of power supply attributes preferably comprises at least one power supply attribute selected from a group of {a second generation rate constraint, a second power reserve, a second time constant, a second marginal power cost, a second energy reserve}.

According to preferred embodiment of the invention, the master control system is adapted to distribute the amounts of corrective electrical power between the first and second power units in direct proportion, or inverse proportion, to values of power supply attributes of same type. This may be implemented by a master feedback loop adapted to subtracting the target set-point electrical power from the total electrical power to generate the power deviation and generate the first and second correction signals by first and second Proportional and Integral regulators (“PI-regulators”), respectively. The first PI regulator may be disposed in-between the power deviation and the first correction signal and the second PI-regulator disposed in-between the power deviation and the second correction signal so as to provide two parallel and independently operating PI-regulators inside the master feedback loop. Each of the PI-regulators has an integrator time constant and gain factor and the master control system may control gain factor settings of the first and second PI-regulators in direct proportion to the values of the power supply attributes of the same type, for example the first and second generation rate constraints or first and second time constants, of the first and second set of power supply attributes.

In another embodiment of the invention, the master control system is adapted to distribute the amounts of corrective electrical power between the first and second power units based on respective values of a first pair of power supply attributes of same type and a second pair of power supply attributes of same type according to a predetermined scheme of priority.

The predetermined scheme of priority provides the master control system with a mechanism for further optimization of how to distribute the production or consumption of the amounts of corrective electrical power between individual power units of the distributed electrical power production system. In certain situations, it may be possible to meet constraints imposed on the power deviation by several different combinations of power units. This is of course particularly likely in embodiments of the present distributed electrical power production system that comprise a plurality of power units and associated sets of power supply attributes such as more than 3, 4 or 5 individual power units. In a situation where the master control system has determined that several different combinations of power units are capable of meeting the constraints by evaluating the respective values of the power supply attributes of a first type, the master control system is preferably adapted to proceed by determining respective values of another type of power supply attributes and use these a secondary decision criteria or rule for determining how to distribute the production or consumption of the amounts of corrective electrical power between the individual power units.

The predetermined scheme of priority may comprise:
determining if constraints imposed on the power deviation can be met by any single power unit of the first and second power units based on the values of the first pair of power supply attributes of same type,
if a single power unit can meet the constraint, selecting the single power unit to produce or consume the amount of corrective electrical power based on values of the second pair of power supply attributes of same type.

In one embodiment of the invention, the predetermined scheme of priority comprises:
selecting a first and a second generation rate constraint as the first pair of power supply attributes of the same type and selecting a first and a second marginal power costs as the second pair of power supply attributes of the same type. Alternatively, the predetermined scheme of priority may comprise selecting a first and a second time constant as the first pair of power supply attributes of the same type; and
selecting a first and a second marginal power costs as the second pair of power supply attributes of the same type.

According to another advantageous embodiment of the invention, the master control system comprises Model Predictive Control (MPC) with a linear performance function representable as a linear program. The first and second power units are represented, in the linear program, by respective linear models such as time-domain models, frequency domain model or state-space models etc. Power supply attributes of the first and second sets of power supply attributes are represented, in the linear program, as respective constraints.

According to this embodiment, a fundamental control problem of minimizing instantaneous power deviation between the target set-point electrical power and the total electrical power is transformed or converted into an optimization problem using MPC techniques. By an appropriate design or specification of the linear performance function, the distribution of corrective electrical power between the first and second power units can be controlled in an optimal way even in embodiments of the inventions which comprise a large number of different power supply attributes to be taken into consideration by the master control system. The linear performance function may be specified so as to comprise all power supply attributes of each of the first and second sets of power supply attributes or only a subset thereof.

The present inventors have demonstrated that the linear performance function, instead of the generally utilized second norm or quadratic performance function, can be applied to the Model Predictive Control formulation of the control/optimization problem at hand. The linear performance function has a significant advantageous impact on the ability to break down the optimization problem to a linear one which can be solved with significantly reduced computational effort compared to traditional quadratic or non-linear optimization problems. The linear performance function allows in practice real-time control of complex distributed power production systems comprising a large number of individual power units with their associated sets of power supply attributes. A particularly attractive embodiment of the invention computes the linear performance function by applying Dantzig-Wolfe decomposition thereto.

This MPC methodology may be more effective than determining and applying a potentially complex collection of empirical rules to determine which ones of the power supply attributes of the first and second sets of power supply attributes that are chosen for computation of the distribution of corrective electrical power between the first and second power units over time. Likewise, an appropriate design of the linear performance function of the MPC based master control system may replace the above-described first and second PI-regulators of the master feedback loop and the associated manipulation of the gain factors to control the distribution of the corrective electrical power between the first and second power units over time.

According to one embodiment of the invention where the master control system comprises MPC, a constraint matrix of the linear program comprises a block-angular structure having block diagonal elements representing respective linear models and power supply attributes of the first and second power units or effectuators. In this embodiment, the block diagonal elements represent individual power units so as to provide an intuitive way of partitioning the linear program into sub-problems. Each sub-problem preferably comprises a single power unit while a master problem or supervisor coordinates tracking of the set-point power or reference power.

The master control system is preferably adapted to apply Dantzig-Wolfe decomposition to the block-angular structure of the constraint matrix of the linear program. The Dantzig-Wolfe decomposition allows the linear optimization problem at hand to be solved with less computational resources or in less time with a given computational capacity. The ability to solve the optimization problem fast is crucial to the ability to retain real-time control of the distributed power production system, in particular power production systems that comprises one or more power units with small time constants.

In certain embodiments of the invention, the master control system is adapted to prematurely terminate computation of the linear program if computation time exceeds a sampling time constraint imposed on the master control system. The master control system determines a current value of the first correction signal from the linear program and determines a current value of the second correction signal from the linear program and supplies the current value of the first correction signal to the first local control system and supply the current value of the second correction signal to the second local control system.

An advantage of this embodiment is that violations of the sample time interval for the transmission of the attribute data to the master control system are avoidable by effecting a premature termination of the linear program and utilize the respective current values of the first and second correction signals as inputs to the first and second local control systems. In this context, “premature” means terminating the linear program before convergence of the Dantzig-Wolfe solution is reached. Such premature termination of the linear program is possible because all major iterations of the Dantzig-Wolfe solution of the linear program lead to feasible outputs. Experimental data obtained by the present inventors have demonstrated that applying such current values of the first and second correction signals to the corresponding local control systems of the power units result in a stable behaviour of the master control loop.

In accordance with a preferred embodiment of the invention, the master control system is adapted to receiving a reserve activation signal or profile from an external source and adding a reserve electrical power indicated by the reserve activation signal to the set-point electrical power. The external source may be a Transmission System Operator (TSO) responsible for monitoring and correcting imbalances between electrical power production and consumption in a certain region or country which includes the present distributed electrical power production system. The reserve activation signal may comprise a continuous time signal defining a complete power supply profile for reserve electrical power, including electrical power supply gradients, which must be followed on short notice.

To ensure that the respective values of the first and second set of power supply attributes accurately reflect the dynamic operating states of respective ones of the first and second power units, the master control system is preferably adapted to receive updated attribute data at sampling time periods smaller than 10 minutes, more preferably smaller than 5 minutes, such as smaller than 2 minutes or 1 minute, or smaller than 20 seconds such as smaller than 2 seconds.

Because different power units may have different time constants, respective values the first and second set of power supply attributes of the attribute data may be acquired or read by the master control system at differing sampling time periods or frequencies so that the updated attribute data may in certain transmission only contain updated values of the power supply attributes associated with a power unit with a small time constant. The portion of the attribute data representing power supply attributes associated with one or more power units with large time constant(s) may not be updated for every new transmission of attribute data. This means that values of the set of power supply attributes of a power unit with a small time constant may be determined or read more frequently (updated at a higher sampling rate) than the values of attributes of power unit(s) with larger time constant(s).

In a preferred embodiment of the invention the first and second sets of power supply attributes comprise a first time constant and a second time constant, respectively. The master control system is adapted to receive the updated attribute data at sampling time periods smaller than one half of the smaller one of the first and second time constants. Complying with this condition ensures that the values of the respective sets of power supply attributes of the first and second power units are at least critically sampled, i.e. sampled at or above their respective Nyquist frequency so as to accurately reflect the respective dynamic operating states of the first and second power units. However, as mentioned above, the respective sets of power supply attributes of the first and second power units may alternatively be determined at different sampling time periods preferably in a manner where values of each set of power supply attributes are at least critically sampled.

A detected power deviation should preferably be corrected as fast as possible and kept to the smallest practical value under stationary operation of the distributed power production system since power deviations are typically economically penalised on a grand total basis by the TSO. The master control system may accordingly be adapted to provide a response time for correcting the power deviation of less than 5 minutes, preferably less than 3 minutes or 1 minutes such as less than 30 seconds; The response time being defined as a time period taken from a step-wise change of the target set-point electrical power of size ΔP until 63% of the resulting power deviation has been corrected by the production or consumption of the amounts of corrective electrical power.

According to a second aspect of the invention there is provided a method of controlling electrical power production of individual power units of a distributed electrical power production system.

The method comprising steps of:

a) generating electrical power by a first power unit of a first type in accordance with a first local control system,

b) determining values of the first set of power supply attributes associated with a dynamic operating state of the first power unit,

c) generating electrical power by a second power unit of a second type in accordance with a second local control system,

d) determining values of a second set of power supply attributes associated with a dynamic operating state of the second power unit,

e) transmitting attribute data from the first and second local control systems representing respective values of their respective sets of power supply attributes to a master control system,

f) comparing a desired or target set-point electrical power with a total electrical power supplied by the first and second power units,

g) computing a power deviation based on the target set-point electrical power and the total electrical power,

h) computing respective amounts of corrective electrical power for the first and second power units based on the attribute data to reduce the power deviation,

i) supplying the respective amounts of corrective electrical power by the first and second power units.

To ensure that respective values of the first set and second sets of power supply attributes of the attribute data accurately reflect the first and second dynamic operating states, respectively, the master control system is preferably adapted to determine updated attribute data at sampling time periods smaller than 10 minutes, more preferably smaller than 5 minutes, such as smaller than 2 minutes, or 1 minute, or smaller than 20 seconds.

The first and second sets of power supply attributes preferably comprise a first time constant and a second time constant, respectively,
the master control system being adapted to receive values of at least one of the first set and second sets of power supply attributes at sampling time periods smaller than one half of a smaller one of the first and second time constants.

### BRIEF DESCRIPTION OF THE DRAWINGS

A preferred embodiment of the invention will be described in more detail in connection with the append drawings in which:

FIG. 1 is a schematic drawing of a distributed electrical power production system in accordance with a first embodiment of the invention,

FIG. 2 is a graph of a MATLAB simulation of response time for delivery of corrective electrical power by a model of the distributed electrical power production system depicted in FIG. 1,

FIG. 3 is a schematic illustration of Dantzig-Wolfe decomposition of a linear performance function of a Model Predictive Control implementation of a master control system of the distributed electrical power production system in accordance with a second embodiment of the invention,

FIG. 4a) shows average execution times per sample as function of the number of power units for solving a Model Predictive Control problem in a master control system of a simulated exemplary distributed electrical power production system,

FIG. 4b) shows average execution or computation time per sample as function of the prediction horizon, N, for solving a Model Predictive Control problem in a master control system of a simulated exemplary distributed electrical power production system,

FIG. 5a) shows variations in computation times of individual samples of an unlimited and a limited Dantzig-Wolfe of a Model Predictive Control problem in a master control system of the simulated exemplary distributed electrical power production system; and

FIG. 5b) illustrates an electrical power output difference between the unlimited Dantzig-Wolfe solution and the prematurely terminated or limited Dantzig-Wolfe solution depicted on FIG. 5a).

### DESCRIPTION OF PREFERRED EMBODIMENTS

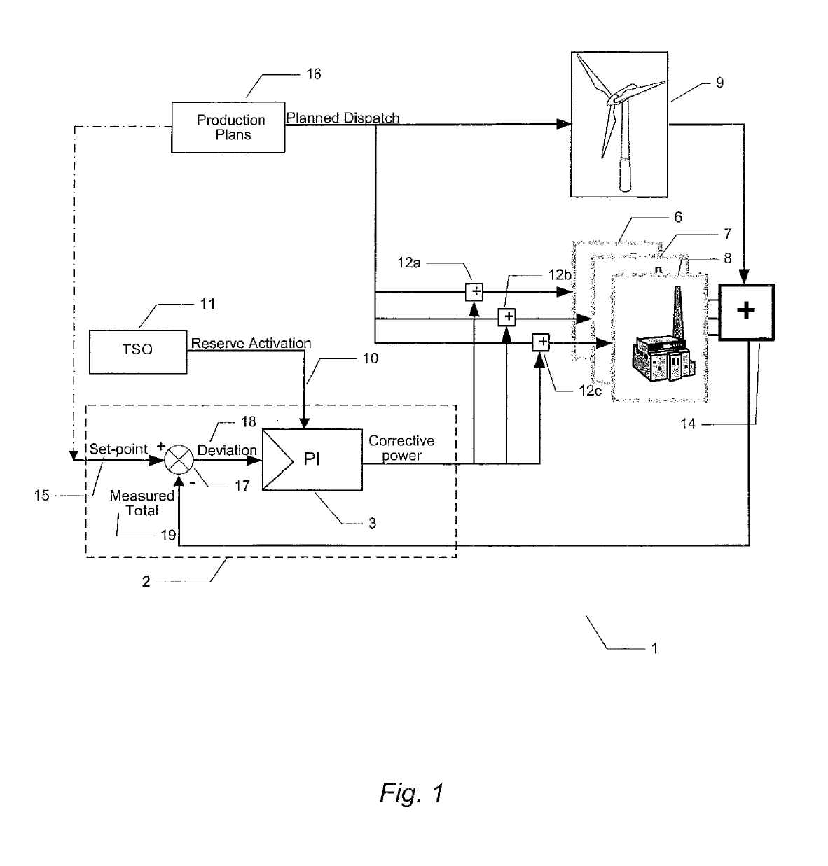

FIG. 1 is a simplified schematic drawing of a distributed electrical power production system 1 according to a preferred embodiment of the invention. The distributed electrical power production system 1 or distributed power system comprises four different types of power units 6, 7, 8 and 9 interconnected with a master control system 2 through a common communication network. The master control system 2 comprises a central computer running a master control program. For simplicity a power grid that presents a load for the power units 6, 7, 8 and 9 has been left out of the present schematic. The central computer is preferably a PC- or UNIX based server. In an exemplary embodiment of the invention, the various below-described computations are performed by the master control program implemented as a collection of DLLs that are generated by a MATLAB/Simulink application. The master control system 2 is running under a central power plant surveillance system running as a Wonderware™ Application Server solution. The central power plant surveillance system makes the required calls to the collection of DLLs.

A power summing device 14 is adapted to measure a total electrical power supplied to, or consumed from, the power grid by the four different types of power units 6, 7, 8 and 9. This measured total electrical power may conveniently be computed by the master control system 2 on basis of measured electrical power supply or consumption for each of the four power units 6, 7, 8 and 9. A local computerized control system (not shown) in each of the power units 6, 7, 8 and 9 measures the electrical power produced or consumed by the power generating unit in question and transmits corresponding data to the master control program through the communication network or interface.

A desired or target set-point electrical power 15 is routed to a subtraction function 17 of the master control system 2 together with the measured total electrical power 11 and a resulting power deviation, which is an indication of imbalance between electrical power production and consumption in the power grid coupled to the distributed electrical power production system 1, is formed at an output of the subtraction function 17 as illustrated. The target set-point electrical power 15 is determined by an economic dispatch program that computes production plans 16 or schedules for each of power units 6, 7, 8 and 9 according to a planned or projected electrical power consumption of the power grid ahead in time such as between 8 and 36 hours ahead.

In addition to the set-point electrical power 15, the distributed electrical power production system 1 is capable of handling an optional electrical power demand in form of a power reserve activation profile 10. The power reserve activation profile 10 is defined by a Transmission System Operator (TSO) 11 in response to determined imbalances between electrical power production and consumption in a certain region or country. In the present embodiment of the invention, the TSO 11 transmits a continuous time reserve activation signal 10 to the master control system 2. The continuous time reserve activation signal 10 defines power supply profiles for reserve electrical power, including electrical power supply gradients, that must be followed by the distributed electrical power production system 1 on short notice (as opposed to the previously-described long-term production plans).

The power deviation 18 indicates a difference between a desired instantaneous electrical power production, as defined by the target set-point electrical power 15, and the electrical power consumption in the power grid coupled to the distributed power production system 1. The power deviation should accordingly be kept to the smallest practical value under stationary operation since deviations are economically penalised on a grand total basis by the TSO 11. It is likewise desirable to correct any electrical power deviation as fast as possible, preferably within 10-60 seconds.

For the purpose of reducing the power deviation 18, the master control system 2 comprises a regulating unit 3 being operative to computing and supplying respective correction signals to three of the four local computerized control systems causing each of the power units 6, 7 and 8 to produce respective amounts of corrective electrical power in accordance with the control signals. In the present distributed power system 1 these correction signals are embodied as respective correction data that are transmitted by the master control system 2 to three local computerized control systems. The correction data are in the present embodiment not transmitted to the windmill park 9 due to difficulties in predicting its power production accurately and a lack of an adequate power production control mechanism. In other embodiments of the invention, it may however be possible to include the windmill park 9 for receipt of correction data if an appropriate local control system, for example a suitable wind park regulator, is provided for the purpose.

In each of the three other local computerized control systems, the correction data are combined with power plan data according to the production plan 16 for the power unit in question. This combination of the correction data and power plan data is illustrated schematically by summing or addition units 12a, b and c. In practice, the addition units may conveniently be arranged inside the respective local computerized control systems of the power units 6, 7 and 8. The supply of correction data to each of the three power units 6, 7 and 8 results in a corresponding generation of corrective amounts of electrical power from each of the power units 6, 7 and 8 in manner that leads to appropriate adjustment of the total measured power 19 in the desired direction, i.e. the direction that reduces the power deviation 18. The adjustment of the total measured power 19 caused by the corrective amounts of electrical power may accordingly result in an increasing or decreasing level of the total measured power 19. The master computer program is adapted to distribute the amounts of corrective electrical power between the three power units 6, 7, and 8 based on respective attribute values of three sets of power supply attributes associated with the three power units 6, 7, and 8 as will be explained in detail below. In the present embodiment of the invention, the distribution of corrective electrical power between the three power units 6, 7, and 8 is controlled by respective gain factors of three parallel and independently operating proportional & integral (“PI) regulators inside the regulating unit 3. The total gain of the independently operating PI-regulators are controlled by a master feedback loop extending around an output of the power summing device 14 and into the total measured power 19 of the subtraction unit or function 17.

Each of the first, second and third power units 6-8 has a set of power supply attributes associated therewith. Each set of power supply attributes comprises three different types of attributes: a generation rate constraint; a time constant and a marginal power cost. In the present distributed electrical power production system 1, the supply of corrective electrical power to reduce a determined power deviation 18 is distributed between the first, second and third power units, 6, 7 and 8 in direct proportion to respective values of the generation rate constraint attribute. However, other ways of distributing the supply of corrective electrical power between the first, second and third power units by applying suitable weights to a distribution scheme are certainly possible to the extent compatible with the overall goal of reducing the detected power deviation 18.

As a numerical example of the operation of the distribution scheme of the present embodiment of the invention, values of the first, second and third generation rate constraints may, at a particular point in time where a power deviation of 20 MW is detected, be determined to: 3 MW/minute, 5 MW/minute and 12 MW/minute, respectively, by the master control system 2 from attribute data sent by the local control systems.

The master control system 2 is adapted to distribute the supply of corrective electrical power in amounts of:

PP1:

Corrective power amount of first power unit:

$$\frac{3}{( 3 + 5 + 12 )} = 0.15 * 20 MW = 3 MW$$

PP2:

Corrective power amount of second power unit:

$$\frac{5}{( 3 + 5 + 12 )} = 0.25 * 20 MW = 5 MW$$

PP3:

Corrective power amount of third power unit:

$$\frac{12}{( 3 + 5 + 12 )} = 0.6 * 20 * MW = 12 MW .$$

Appropriate correction signals are accordingly forwarded by the master control system 2 to the respective local control systems causing each of the power units to increase its power production in accordance with the determined distribution. The master control system 2 may advantageously be adapted to take more than one type of power supply attribute into consideration when distributing the amount of corrective electrical between the first, second and third power units. If the above-mentioned power deviation had been 3 MW, the need for corrective power could clearly have been met by any of the first, second and third power units or any combination thereof. In such case the master control system 2 may advantageously be adapted to distribute the corrective power production based on respective values of a secondary type power supply attribute according to a predetermined scheme or rule set of priority for exploiting the different types of power supply attributes in each of sets of power supply attributes. In one exemplary embodiment of the invention, the power supply attributes which represent the respective marginal power costs of the first, second and third power units 6, 7 and 8 are selected as secondary priority. According to this embodiment, the master control system 2 will commission all production of corrective electrical power to the single power unit which has the lowest marginal power costs if a specific requirement for corrective power can be met by anyone of the first, second and third power units as described above.

In an exemplary embodiment of the invention, the first power unit 6 is a fossil fuel-fired plant, the second power unit 7 is a rechargeable energy reservoir and the third power unit 8 is biomass fired plant. The fourth power unit is as previously mentioned a windmill park 9. The time constant of the rechargeable energy reservoir 7 is very small such as between 10 and 30 seconds leading to a rapid response time for the delivery of corrective power. On the other hand, the rechargeable energy reservoir 7 has finite energy storage capacity and therefore, oppositely to the fossil fuel-fired plant 6, incapable of continuous operation even given unlimited fuel supply. Accordingly, once the rechargeable energy reservoir 7 has delivered a certain amount of corrective power, it will reach a dynamic operating state where it is depleted of energy and needs recharging to restore its capability to supply further amounts of corrective power. The master control system 2 may, however, be informed about the dynamic operating state of the rechargeable energy reservoir 7 through relevant values of the frequently transmitted attribute data which advantagously may comprise an additional energy reserve power supply attribute. This latter power supply attribute indicating a current value of the energy reserve of the rechargeable energy reservoir 7 for example measured in MWh or in percent of a fully charged state. If the current value of the energy reserve is small due to a depleted dynamic operating state of the rechargeable energy reservoir 7, the master control system 2 will be able to distribute the production of corrective electrical power to other power producing units of distributed electrical power production system 1 for a period of time until the rechargeable energy reservoir 7 has been sufficiently recharged to commence operation. Once again, the frequent transmission of updated attribute data between the local control system of the rechargeable energy reservoir 7 and the master control system 2 will ensure that the master control system is informed about the recharged dynamic operating state of the rechargeable energy reservoir 7.

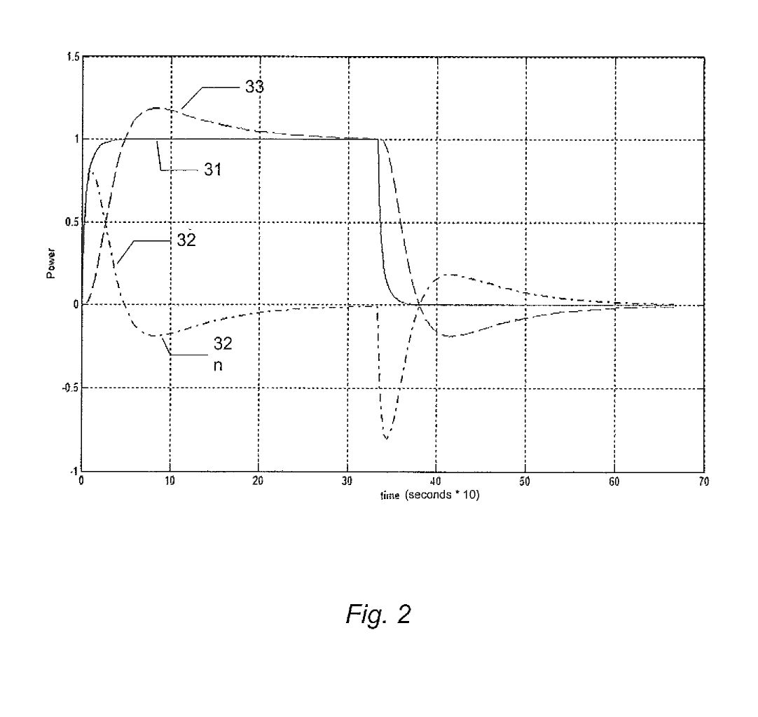

FIG. 2 illustrates an exemplary MATLAB simulation of response time for delivery of corrective electrical power by two different types of power units of the distributed electrical power production system 1 depicted in FIG. 1. The plot shows how the delivery of corrective electrical power from the power units 6 & 7 evolves over time in response to a step-wise increase in the set-point point power 15 (refer to FIG. 1) on 1 unit (arbitrary scale) at t=10 seconds. The scale on the y-axis is electrical power in relative units with zero representing steady-state electrical power production before the injected step-wise power increase. The unit on the x-axis indicates time in seconds times 10 so that the end point of the x-axis corresponds to t=700 seconds.

Plot 31 shows total supplied corrective power over time as simulated/measured at the output of summing function 14 while plot 32 shows an amount of corrective power delivered by the rechargeable energy reservoir 7 and plot 33 shows an amount of corrective power delivered by the fossil fuel-fired plant 6. The production of corrective power is distributed between the power units 6 & 7 according to their respective time constants from a time period t=10 sec to t=60 seconds. After the latter point in time, the rechargeable energy reservoir 7 is depleted of energy and unable to deliver further amounts of the corrective power, but at this point in time the fossil fuel-fired plant 6 takes over all further delivery of the corrective power during the initial 350 seconds. After t=60 seconds, it has been illustrated how the rechargeable energy reservoir 7 enters a recharging state or phase operating as a power consumption unit as opposed to the initial operation as a power generating unit.

The plot of the total supplied corrective power 31 demonstrates how rapid and accurate the present disturbed power production system 1 is capable of eliminating or at least suppressing transient power imbalances or transient power deviations, by distributing the production of corrective electrical power between a mixture of rapid and slower (i.e. having smaller and large time constants, respectively) responding power units of different types. The response time of the present disturbed power production system 1 can be determined from plot 31 to around 15-20 seconds from the step-wise change of the target set-point electrical power of size ΔP=1 unit occurring at t=10 seconds until 63% of the resulting power deviation has been corrected by the production of appropriate amounts of corrective electrical power.

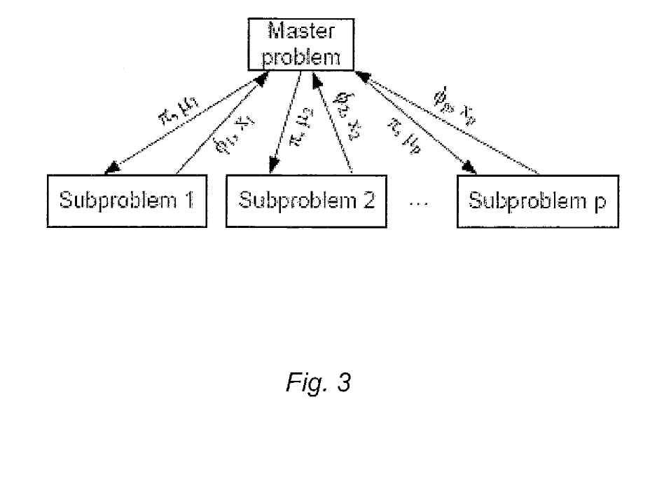

FIG. 3 is a schematic illustration of so-called Dantzig-Wolfe decomposition of a linear performance function of a Model Predictive Control implementation of the master control system of the distributed electrical power production system in accordance with a second embodiment of the invention. The present distributed electrical power production system has many features in common with the distributed electrical power production system depicted on FIG. 1 except for the PI regulating unit (item 3 on FIG. 1). In the present embodiment, the three parallel and independently operating PI regulators inside the regulating unit 3 of the master control system have been replaced by a control function which relies on Model Predictive Control (MPC) with a linear performance function to determine the optimum distribution of production of corrective electrical power between the power units. The fundamental control problem associated with minimizing instantaneous power deviation between the set-point or reference electrical power (item 15 on FIG. 1) and the total electrical power has inventively been transformed or converted into an optimization problem using MPC techniques.

The present inventors have furthermore demonstrated that a linear performance function, instead of the standard quadratic, performance function, can be applied to the Model Predictive Control formulation of the control/optimization problem at hand. This finding has significant impact on the ability to break down the optimization problem to a linear optimization problem which can be solved with significantly reduced computational effort compared to traditional quadratic or non-linear optimization problems. A particularly attractive embodiment of the invention computes the linear performance function by applying Dantzig-Wolfe decomposition thereto.

Dantzig-Wolfe decomposition is a technique for solving linear problems faster. It works particularly well on optimization problems which can be decomposed or split into several smaller sub-problems with some coordinating or master problem facilitating a certain level of interaction. Dantzig-Wolfe decomposition is therefore very well-suited to power plant portfolio control because this application comprises a plurality of power units, such as power generating and power consuming units, which has to be controlled individually with a common goal of obtaining an electrical power production which tracks a set-point or reference power to ensure continuous balance between produced and consumed electrical power.

In the present embodiment of the invention, the linear performance function, Φ is expressed as:

$$min φ = {\sum }_{k = 1}^{N} {‖ {y}_{tot , k} - {r}_{tot , k} ‖}_{{q}_{t} , k} + {\sum }_{i = 1}^{p} ( {\sum }_{k = 0}^{N - 1} {‖ {y}_{i , k + 1} - {r}_{i , k + 1} ‖}_{{q}_{ei + 1} , k} + {q}_{iu , k + 1} {y}_{i , k + 1} + {‖ Δ u ‖}_{{q}_{Δ u} , k} ) \\ such . that \\ {x}_{i , k + 1} = {Ax}_{i , k} + {Bu}_{i , k} i = 1 , 2 , … , p \\ {y}_{i , k} = {Cx}_{i , k} i = 1 , 2 , … , p \\ \underline{{u}_{i , k}} \leq {u}_{i , k} \leq \overline{{u}_{i , k}} k = 1 , 2 , … , N i = 1 , 2 , … , p \\ \underline{Δ {u}_{i , k}} \leq Δ {u}_{i , k} \leq \overline{Δ {u}_{i , k}} k = 1 , 2 , … , N i = 1 , 2 , … , p \qquad ( 1 )$$

wherein:

p: the number of power units of the distributed electrical power production system;

N: prediction horizon expressed as an integer number of sample time intervals;

x_{i,k} and y_{i,k}: State-space formulation of a transfer function of the k-th power unit;

u_{i,k} and u̅_̅{̅i̅,̅k̅}̅ are lower and upper power reserve attributes, respectively, of the k-th power supply attribute of the i-th power unit.

A master problem is expressed by the overall term

$${\sum }_{k = 1}^{N} {‖ {y}_{tot , k} - {r}_{tot , k} ‖}_{{q}_{t} , k}$$

Equation (1) is rewritten into a linear program with a block angular structure such that:

$$min φ = {c}_{0}^{T} {x}_{0} + {c}_{1}^{T} {x}_{1} + {c}_{2}^{T} {x}_{2} + … + {c}_{p}^{T} {x}_{p} \\ s . t . \\ [ \begin{matrix}{A}_{0} & {A}_{1} & {A}_{2} & … & {A}_{p} \\ & {B}_{1} & & & \\ & & {B}_{2} & & \\ & & & ⋱ & \\ & & & & {B}_{p}\end{matrix} ] [ \begin{matrix}{x}_{0} \\ {x}_{1} \\ {x}_{2} \\ ⋮ \\ {x}_{p}\end{matrix} ] \geq [ \begin{matrix}b \\ {d}_{1} \\ {d}_{2} \\ ⋮ \\ {d}_{p}\end{matrix} ] \qquad ( 2 )$$

wherein matrix elements A₀ are constraints related to the master problem;

A₁ A₂ A₃ . . . Aₚ are respective contributions from individual power units to the master problem;

Matrix elements B₁ B₂ B₃ . . . Bₚ and their associated vector elements d₁ d₂ . . . dₚ are respective power supply attributes of the power units;

Equation (2) is a block-angular structure as required for Dantzig-Wolfe decomposition to be effective. The block-diagonal elements represent individual power units, or effectuators, which provides an advantageous intuitive way of partitioning the equation or program into sub-problems. Each sub-problem preferably comprises a single individual power unit while the master problem or supervisor coordinates tracking of the set-point power or reference power.

Before a concrete Dantzig-Wolfe decomposition can be started an initial feasible solution, or initial condition, is needed for each of the sub-problems. In the present embodiment all sub-problems are of similar structure and only constraints on the correction signals are imposed. This means that an appropriate initial feasible solution can be found through the below-mentioned steps 1-4. Each sub-problem comprises 3 groups of optimization variables:
1. Correction signals
2. Variables related to the ∥Δu∥_{q}_{_{Δu}}_{,k} portion of equation (1)
3. Variables related to the ∥y_{i,k+1}−r_{i,k+1}∥_{q}_{_{ei−1}}_{,k} portion of equation (1)
1) Take the most recently computed correction signal for each power unit and repeat that correction signal throughout the chosen prediction horizon represented by N;
2) Check that the last correction signal within the chosen prediction horizon for each power unit does not violate the upper and lower power reserve attributes—otherwise force the correction signal inside the upper and lower power reserve attributes. This procedure provides the initial guess for group 1 above;
3) Calculate difference values of the correction signals of group 1 per power unit. The result of this operation is the second part of the initial solution;
4) Choose a constant expressed in terms of power deviation which is definitely larger than the largest deviation between the set-point power and estimated total power throughout the prediction horizon, Apply this constant as the initial guess for group 3 above.

From this point and forward, the actual computation of the individual correction signals throughout the selected prediction horizon for the power units follows standard Dantzig-Wolfe solution algorithms.

Below experimental results on computation time for solving a specific Model Predictive Control scheme based on Dantzig-Wolfe decomposition are outlined and compared to computation times for solving the same MPC problem in centralized format as given by equation (1).

In the present experimental results, a sample time interval or period for the master control system has been chosen to 5 seconds, but the sample time interval may vary widely depending on dynamics of the power units included in the distributed electrical power production system. In this section we shall investigate behaviour of the master control system when different parameters of the distributed power production system are varied. In the following section problems of different size will be treated. Each of the power units comprises 3N optimization variables and 8N constraint equations where N is a chosen prediction horizon expressed as an integer number of sample time intervals as previously explained.

The master problem adds 2N constraints to the optimization problem at hand. So with p power units, a centralised optimization problem with 3Np optimization variables and 8Np+2N constraints is posed. When applying Dantzig-Wolfe decomposition, p optimization problems with 3N optimization variables and 8N constraints, in addition to the RMP with 2N constraints are posed. Furthermore, a variable number of optimization variables, depending on the number of iterations needed is additionally required. The solutions devised in this section were found by using an active-set Linear Programming Solver (LP solver) which scales cubicly with the number of optimization variables. The LP-solver has been used for solving both the centralised problem and the Dantzig-Wolfe decomposition or formulation so as to make solution times comparable. The largest deviation in elements of a solution vector of the optimal point between the centralised solution and the Dantzig-Wolfe solution is of magnitude of 10⁻⁶. This deviation is within expected precision of the algorithm and has accordingly led the inventors to conclude that the two algorithms do converge to the same optimal point.

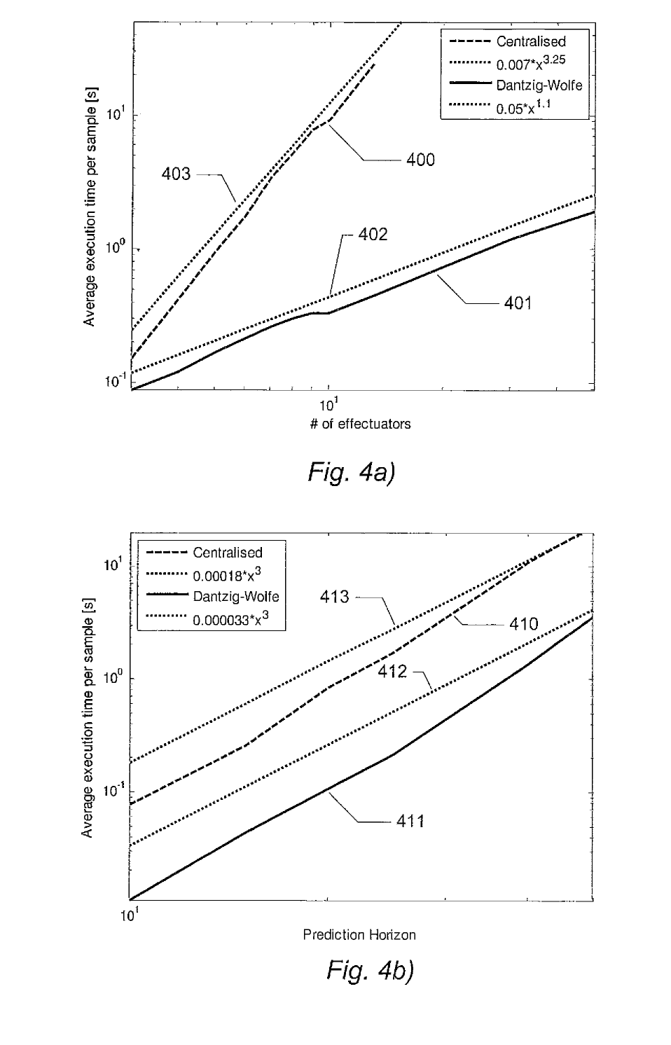

FIG. 4a) shows the average execution time in seconds per sample as a function of the number of power units or effectuators included in the simulation for two different cases. Notice the logarithmic scale on both axes.

The first case is a centralised solution as depicted on curve 400 wherein the execution time scales approximately cubicly with the number of power units. In theory the centralised solution should scale exactly cubicly, but computational overhead is imparted by a mixture of an increasing number of iterations to converge for the LP-solver and increased overhead of the MATLAB computing program with growing problem size. The second case is the solution based on Dantzig-Wolfe decomposition as depicted on curve 401. Execution time for the Dantzig-Wolfe decomposition scales almost linearly with the number of power units. Part of the overhead associated with running the Dantzig-Wolfe algorithm is master problem which grows faster when a large number of subsystems are used since a multi-column generation scheme is used. The dotted curve 402 of FIG. 4a) is an exemplary plot of an essentially linear function for comparison with curve 401 so as to verify the approximately actual linear growth of curve 401. Likewise dotted curve 403 is a plot of an exemplary essentially cubic function for comparison purposes with curve 403 so as to verify actual exponential growth of curve 403.

FIG. 4b) shows average execution or computation time per sample in seconds for solving the present Model Predictive Control problem as a function of the chosen prediction horizon, N, for the two different cases outlined above. As expected execution or computation time still scales cubically with the prediction horizon for both of the cases as illustrated on curves 410 and 411 Lower curve 411 represents execution time for Dantzig-Wolfe decomposition while upper curve 410 represents the centralised solution. An increased prediction horizon leads to an increased sub-problem size. As readily apparent from FIG. 4b), the average computation time for samples drops dramatically by application of the Dantzig-Wolfe based decomposition of the linear performance function—and scalability is also improved. Dotted curves 412 and 413 are plots of exemplary essentially cubic functions for comparison purposes with curve 411 and curve 410, respectively, so as to verify actual exponential growth of the latter curves.

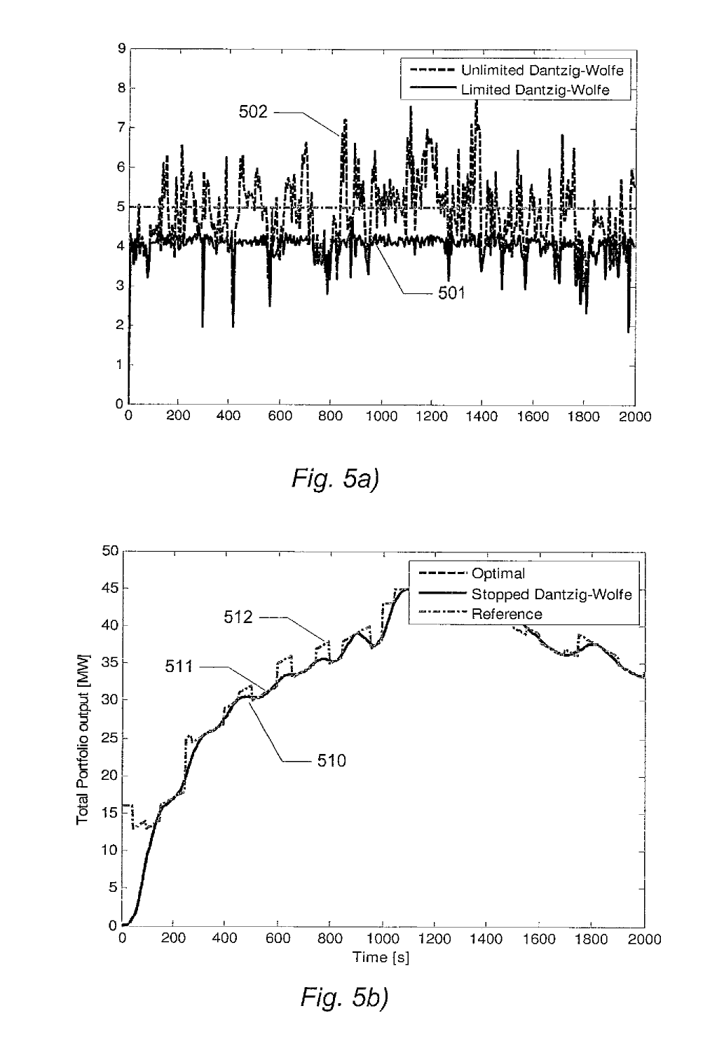

FIG. 5a) shows variation in computation time of individual samples for an exemplary embodiment or case with fixed values of N=50 and p=6. As illustrated, the average computation time per sample is just below five seconds, but the sample computation time fluctuates and regularly exceeds five seconds which is the chosen sample time interval. A controller of an operative distributed electrical power production system cannot be allowed to violate the time constraint set by the sample time interval because it ensures critical sampling of the fastest (i.e. smallest time constant) power unit of the distributed power production system. However, to cope with such violations of the sample time interval the present inventors have utilized another advantageous property of a Dantzig-Wolfe based solution in that all major iterations of the Dantzig-Wolfe based solution leads to feasible outputs. Experimental data obtained by the present inventors have indicated that deriving and applying corrective signals to the respective power units from a prematurely terminated linear program results in a stable behaviour of the master control loop.

This property means it is possible to terminate the optimization procedure prematurely and utilize current values of the relevant variables such as the respective correction signals to the power units without violating constraints.

The curves 510 and 511 plotted in FIG. 5b) illustrates an electrical power output difference between an optimal or converged computation of a Dantzig-Wolfe solution, represented by plot 512, and a prematurely terminated or limited Dantzig-Wolfe solution. The plots 510 and 511 correspond to respective ones of the average computation time per sample curves for the unlimited and limited Dantzig-Wolfe solutions depicted on FIG. 5a) above. As illustrated, there is substantially no visible difference in electrical power output between plots 510 and 511 so that both Dantzig-Wolfe solutions track the set-point or reference power as depicted on plot 512 equally well for practical purposes. This feature makes the Dantzig-Wolfe decomposition very attractive for real-time control purposes because termination of the MPC algorithm is allowable if there is insufficient computation time available to reach convergence.

1. A distributed electrical power production system comprising:
a first power unit of a first type adapted to produce electrical power in accordance with a first local control system,
the first power unit having a first set of power supply attributes associated with a dynamic operating state of the first power unit,
a second power unit of a second type adapted to produce electrical power in accordance with a second local control system,
the second power unit having a second set of power supply attributes associated with a dynamic operating state of the second power unit,
a master control system adapted to receive attribute data from the first and second local control systems representing respective values of their respective sets of power supply attributes,
the master control system being adapted to compare a desired or target set-point electrical power with a total electrical power supplied by the first and second power units and form a power deviation based thereon,
the master control system being operative to reducing the power deviation by supplying first and second correction signals to the first and second local control systems, respectively, causing the first and second power units to produce or consume respective amounts of corrective electrical power in accordance therewith,
the master control system being adapted to distribute the amounts of corrective electrical power between the first and second power units based on the attribute data.

2. A distributed power production system according to claim 1, wherein at least one of the first and second power units is adapted to produce electrical power to the distributed power production system and consume electrical power from distributed power production system.

3. A distributed power production system according to claim 1, wherein at least one of the first and second power units is adapted to exclusively consume electrical power from the distributed power production system.

4. A distributed power production system according to claim 1, wherein at least one of the first and second power units is adapted to exclusively produce electrical power to the distributed power production system.

5. A distributed power production system according to claim 1, wherein the first set of power supply attributes comprises at least one power supply attribute selected from a group of {a first generation rate constraint, a first power reserve, a first time constant, a first marginal power cost, a first energy reserve},
the second set of power supply attributes comprising at least one power supply attribute selected from a group of {a second generation rate constraint, a second power reserve, a second time constant, a second marginal power cost, a second energy reserve}.

6. A distributed power production system according to claim 1, wherein the master control system is adapted to distribute the amounts of corrective electrical power between the first and second power units based on values of power supply attributes of same type selected from the first and second sets of power supply attributes.

7. A distributed power production system according to claim 6, wherein the master control system is adapted to distribute the amounts of corrective electrical power in direct proportion, or inverse proportion, to the values of power supply attributes of same type.

8. A distributed power production system according to claim 1, wherein the master control system is further adapted to:
receiving a reserve activation signal or profile from an external source,
adding a reserve electrical power indicated by the reserve activation signal to the set-point electrical power.

9. A distributed power production system according to claim 7, wherein the master control system is adapted to distribute the amounts of corrective electrical power between the first and second power units based on respective values of a first pair of power supply attributes of same type and a second pair of power supply attributes of same type according to a predetermined scheme of priority.

10. A distributed power production system according to claim 9, wherein the predetermined scheme of priority comprises:
determining if constraints imposed on the power deviation can be met by any single power unit of the first and second power units based on the values of the first pair of power supply attributes of same type,
if a single power unit can meet the constraint, selecting the single power unit to produce or consume the amount of corrective electrical power based on values of the second pair of power supply attributes of same type.

11. A distributed power production system according to claim 9, wherein the predetermined scheme of priority comprises:
selecting a first and a second generation rate constraint as the first pair of power supply attributes of the same type,
selecting a first and a second marginal power costs as the second pair of power supply attributes of the same type.

12. A distributed power production system according to claim 9, wherein the predetermined scheme of priority comprises:
selecting a first and a second time constant as the first pair of power supply attributes of the same type,
selecting a first and a second marginal power costs as the second pair of power supply attributes of the same type.

13. A distributed power production system according to claim 1, wherein the master control system comprises a master feedback loop adapted to:
generating the first and second correction signals,
subtracting the target set-point electrical power from the total electrical power to generate the power deviation.

14. A distributed power production system according to claim 13, wherein the master feedback loop comprises:
a first Proportional and Integral regulator disposed in-between the power deviation and the first correction signal,
a second Proportional and Integral regulator disposed in-between the power deviation and the second correction signal,
each Proportional and Integral regulator having an integrator time constant and a gain factor,
the master control system being adapted to distribute the amounts of corrective electrical power between the first and second power units by controlling the respective gain factors of the first and second Proportional and Integral regulators.

15. A distributed power production system according to claim 1, wherein the master control system comprises Model Predictive Control with a linear performance function representable as a linear program; wherein
the first and second power units are represented, in the linear program, by respective linear models such as time-domain models, frequency domain model or state-space models, and
power supply attributes of the first or second sets of power supply attributes are represented, in the linear program, as respective constraints.

16. A distributed power production system according to claim 15, wherein a constraint matrix of the linear program comprises a block-angular structure with block diagonal elements representing respective linear models and power supply attributes of the first and second power units.

17. A distributed power production system according to claim 16, wherein the master control system is adapted to apply Dantzig-Wolfe decomposition to the block-angular structure of the constraint matrix of the linear program.

18. A distributed power production system according to claim 17, wherein the master control system is adapted to:
prematurely terminate computation of the linear program if computation time exceeds a sampling time constraint imposed on the master control system,
determine a current value of the first correction signal from the linear program and determine a current value of the second correction signal from the linear program,
supply the current value of the first correction signal to the first local control system and supply the current value of the second correction signal to the second local control system.

19. A distributed power production system according to claim 1, wherein the first and second power units are selected from a group of {fossil fuel-fired plant, biomass fired plant, on-shore or offshore windmill plant, waste incineration plant, nuclear power plant, electrical vehicle, rechargeable energy reservoir, cold storage house, house-hold appliance, electrical motor}.

20. A distributed power production system according to claim 1, wherein the first or second power units comprises a rechargeable energy reservoir having a finite energy storage capacity over a charge/recharge cycle.

21. A distributed power production system according to claim 1, wherein the master control system is adapted to receive updated attribute data at sampling time periods smaller than 10 minutes.

22. A distributed power production system according to claim 1, wherein the first and second sets of power supply attributes comprise a first time constant and a second time constant, respectively
the master control system being adapted to receive updated attribute data with a sampling time period smaller than one half of a value of a smaller one of the first and second time constants.

23. A distributed power production system according to claim 1, wherein a response time for correcting the power deviation is less than 5 minutes;
the response time being defined as a time period taken from a step-wise change of the target set-point electrical power of size [Delta]P until 63% of the resulting power deviation has been corrected by production or consumption of the amounts of corrective electrical power.

24. A method of controlling electrical power production of individual power units of a distributed electrical power production system, the method comprising steps of:
a) generating electrical power by a first power unit of a first type in accordance with a first local control system,
b) determining values of a first set of power supply attributes associated with a dynamic operating state of the first power unit,
c) generating electrical power by a second power unit of a second type in accordance with a second local control system,
d) determining values of a second set of power supply attributes associated with a dynamic operating state of the second power unit,
e) transmitting attribute data from the first and second local control systems representing respective values of their respective sets of power supply attributes to a master control system,
f) comparing a desired or target set-point electrical power with a total electrical power supplied by the first and second power units,
g) computing a power deviation based on the target set-point electrical power and the total electrical power,
h) computing respective amounts of corrective electrical power for the first and second power units based on the attribute data to reduce the power deviation,
i) supplying the respective amounts of corrective electrical power by the first and second power units.

25. A method of controlling electrical power production according to claim 24, wherein the master control system is adapted to determine updated attribute data at sampling time periods smaller than 10 minutes.

26. A method of controlling electrical power production according to claim 24, wherein the first and second sets of power supply attributes comprise a first time constant and a second time constant, respectively,
the master control system being adapted to receive values of at least one of the first set and second sets of power supply attributes at time periods smaller than one half of a smaller one of the first and second time constants.
